(19) United States
(12) Patent Application Publication
(10) Pub. No.: US 2019/0189107 A1
(43) Pub. Date: Jun. 20, 2019

(54) SOUND PLAYING WOOD

(71) Applicant: Kirsi Ihalainen, Helsinki (FI)

(72) Inventor: Kirsi Ihalainen, Helsinki (FI)

(21) Appl. No.: 16/327,616

(22) PCT Filed: Aug. 22, 2017
(86) PCT No.: PCT/FI2017/050587

§ 371 Date: Feb. 22, 2019

(30) Foreign Application Priority Data
Aug. 22, 2016 (FI) 20160211

(51) Int. Cl. G10K 15/04; H04R 1/02

(52) U.S. Cl. CPC G10K 15/04; H04R 2201/028; H04R 1/025

(57) ABSTRACT

According to the invention, the sound playing wood (1) includes a wood (2), a leg (3) and equipment inside the wood (2). The wood (2) is set on the leg (3), and a hole (12) is made at the bottom and inside the wood. The equipment includes an amplifier (4) and a computer (5), which are attached to the inner surface of the hole (12) inside the wood (2). The equipment also includes a transducer (6) attached to the inner surface of the wood (2) to make the wood (2) vibrate. By vibrating the wood (2) with the transducer (6), the wood is made to resonate and reproduce sound.

### TECHNICAL FIELD OF THE INVENTION

The purpose of the invention is to function as a device that is sensible with different senses for well-being purposes.

### BACKGROUND TO THE INVENTION

There are previously known different devices with which it is possible to relax and calm down. These devices can be for example different sound production devices, tactile devices, or different devices producing odours.

### PURPOSE OF THE INVENTION

The purpose of the invention is to bring out a new kind of a device, which produces sound and tactile stimuli simultaneously. The device is executed with the newest sound technology with which the wood itself starts to resonate in order to be heard, and vibrate in order to be felt while hugging the device.

No similar products can be found from the market, and especially not for well-being purposes. The product has presumably huge markets, because the lack of forests in big cities around the world is a remarkable problem, and the hectic way of life of people does not necessarily provide the time to go to the forest and to relax there.

The purpose of the invention is to also make the Finnish forests and nature more familiar to the urbanised people around the world, and also to commemorate the sounds and soundscapes of the Finnish forests. If the forests die, also these sounds will die.

### DESCRIPTION OF THE INVENTION

According to the invention, the sound playing wood includes a wood, a leg, and also equipment inside the wood. The wood is set on top of the leg, and a hole is made at the bottom and inside the wood. The equipment includes an amplifier and a computer which are attached to the inner surface of the hole inside the wood. The equipment also includes a transducer attached to the inner surface inside the wood in order to shake and vibrate the wood. By vibrating the wood with the transducer, the wood is made to resonate and reproduce the sound.

In one adaptation of the device, the transducer is attacked to the bottom surface of the hole, the central part of the wood.

In one adaptation of the device, the leg is hollow.

In one adaptation of the device, the hole has an air-flow connection to the outside of the device through the leg functioning as a ventilation channel for the equipment inside the wood.

In one adaptation of the device, the leg includes a bottom part flange at the bottom of the leg and also pins organised under the bottom part flange.

In one adaptation of the device, the equipment includes a power cord, which is organised to go outside through the leg from the inside of the wood.

In one adaptation of the device, on the bottom surface of the bottom part flange, there is a chute for the power cord.

In one adaptation of the device, the electric and electronic equipment includes a Bluetooth connection.

In one adaptation of the device, the electric and electronic equipment includes a Wi-fi connection.

In one adaptation of the device, the wood is made of naturally dried dead pine, birch or spruce.

Kelosound consists of the wood made of naturally dried dead pine, which is attached to the leg/stand. It is possible to obtain the Kelosound wood for your own home, and it is meant to bring nature closer to the people. The wood functions as a relaxing element in our hectic everyday life. The wood includes different soundscapes from Finnish nature and forests with different animal sounds. The sounds are controlled with a mobile application with which the listener can choose which sounds and soundscapes to listen. The sounds coming from the wood, the vibration of the wood, and the odour of the wood relaxes and creates a nature experience, when there is no possibility to go to the forest.

The product is also based on the latest sound technology and programming technology in the form of a computerised application, which is attached to the wood to control the sound.

The height of the wood is approximately 80 cm-1 m, and the diameter about 30-35 cm. The wood material can be naturally dried dead pine, birch or naturally dried dead spruce. Inside, and to the bottom of the wood, a suitable square hole is made. The width and depth of the hole may vary 18-25 cm. The top part flange of the leg will cover the hole in the wood. The diameter of the top part flange is 30 cm and the bottom part flange 54 cm. The tube of the leg is 60-70 cm, and the material of the leg is polished aluminium.

The leg is in three parts for easier packing and transit of the wood and the leg to the customer. The customer assembles the product after buying it at home according to the instructions that come with it. The assembly happens by pressing the unattached tube part to the top part flange and the bottom part flange of the leg. The top part flange has been left as attached to the wood on purpose, when the product goes to the customer, in order to cover the equipment inside the hole in the wood, and also for easier assembly of the product.

The tube is completely hollow and the customer will string the power cord coming from the inside of the wood through it and to come out from under the bottom part flange of the leg. Under the bottom part flange of the leg, there are small plastic pins, which lift the product up from the ground enough for the power cord to come from under the leg. The plastic pins under the leg make it easier to move the wood, because it slides easily on the floor. The plastic pins are also made of floor-friendly material, and will not leave any slide marks to the floor.

The height of the leg can be chosen by the customer, and in principle it can be of any height, but for the razzle-dazzle looks of the wood, and for it to be huggable, the best heights for the leg are between 60-70 cm. The leg being hollow and the gap under the leg enable the airflow inside the wood along the tube, and therefore function as a ventilation for the equipment inside the wood, so that it will not be able to heat up.

The power cord comes from the inside of the wood, and when packed, it is wrapped around the top part flange of the leg. When assembling the product and after stringing the power cord, there is a chute attached under the bottom part flange of the leg for the power cord. The customer will press the power cord coming from the tube to the chute, which will lead the power cord from underneath the leg. This way the cord is lead out safely without being trapped or drifted under the leg's plastic pins when moving the wood.

There is a power switch in the power cord between the leg and the plug, which indicates with a light when the product is powered on. The equipment inside the wood is powered on and off from the switch. After pressing the switch, the equipment will automatically connect with Bluetooth to the Kelosound application installed to the customer's phone/mobile device.

The equipment will be inside the wood in its entirety. The sound playing equipment consists of a transducer, an amplifier with it, and a computer. The equipment is attached to the wood by screwing it up to the surface of the wood. The hole in the wood is square in order to install the equipment more easily to the inner surface of the wood. The square hole is also faster to do than a round hole. The top and bottom surface of the wood are sanded and varnished in order to keep the surface of the wood in good condition, and if there is dust collecting on top of the wood, it is easy for the customer to dust the top of the wood. The hole inside the wood is also sanded completely in order to install the devices easily without any splintered surfaces.

The transducer is not a speaker, instead it makes the wood vibrate in a way that the wood itself becomes the speaker. The wood's own resonance thus enters the soundscape, making each wood sound unique.

The transducer is attached with the help of a wood installation metal plate with two screws to the heart of the wood, i.e. on the bottom of the hole. The bottom of the hole has to be completely even and sanded in order for the vibration surface of the device to get the best contact to the wood and to make the wood play the sound. The device is installed to the heart of the wood, because then the wood will play and resonate the best overall. When attaching the device to the wood's central part, it will guarantee that the wood plays the sound evenly overall. Then the wood will conduct the sound in the best possible way for it to play as loudly from every point of the wood.

The operating system of the computer will be installed in a way that the device will automatically turn on when the power is switched on from the power switch of the wood. The device will also turn off from the switch. Also, the Bluetooth connection and Wi-fi connection will turn on automatically when the device turns on. When the device turns on, the Kelosound application in the device will turn on automatically, and then the wood is ready to play the sounds which are selected with the mobile application. Physically, all the sounds are located in the computer database. When new sounds are bought, they will be downloaded with the mobile application to the computer inside the wood. This helps to ensure that the memory of the customer's phone or mobile device will not choke, and the expensive sounds are secured in the computer inside the wood.

In the Kelosound mobile application, it is possible to choose soundscapes, to read stories about them, and to watch photos about them. In the basic view of the application, the soundscapes are shown one below another as photos, and from them, one, several, or all soundscapes in the application can be chosen.

After selecting the soundscapes, the customer can observe the soundscapes from a playlist. The sounds will play immediately, when the first soundscape is selected. The customer can also stop the sound when wanted by pressing the pause button, and continue to play by pressing it again, whereupon the button is a play button. From the menu under the Kelosound logo, the customer can choose to play the sounds forever with the repeat function. With the shuffle function, the customer can set the application to randomly select the playing order of the sounds from the playlist. The playlist can be browsed with the swipe action from right to left, and the soundscapes on the basic view list from down to up. There will be a shop function added to the application, from where the customer can see the new appeared soundscapes, which can be bought and downloaded when wanted to the soundscape list. At the shop, a short sound sample clip can be heard, and a photo seen, in order to determine what the soundscape that can be bought is all about.

The sound files are located physically in the computer inside the wood, and when new soundscapes are bought, they will also be downloaded there. This way the memory of the mobile device will not choke, and the soundscapes already bought will be secured. This makes it possible to play the sounds from the wood with any mobile device, as long as the mobile application is installed to it.

### LIST OF THE FIGURES

In the following, the invention is presented in detail by referring to the attached drawings, where

FIG. 1 shows one adaptation of the sound playing wood, and

FIG. 2 shows a cross-section of the adaptation of the sound playing wood.

### DETAILED DESCRIPTION OF THE INVENTION

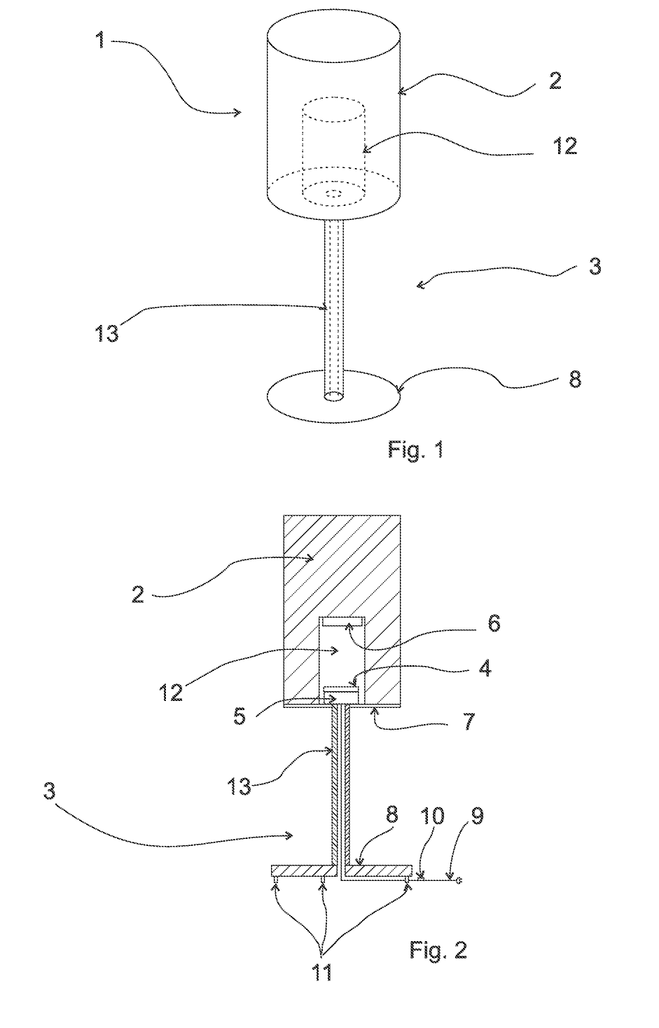

In FIG. 1, the sound playing wood 1, including a wood 2 and a leg 3, is presented. There is a hole 12 for the equipment at the bottom and inside the wood 2. The leg includes a bottom part flange 8 attached to a tube part 13.

In FIG. 2, a cross-section of the sound playing wood 1 of FIG. 1 is presented. Also presented in FIG. 2 is a transducer 6, which is attached to the inner surface of the hole 12 inside the wood 2. An amplifier 4 and a computer 5 to play the sounds are also in the hole 12. The transducer is attached to the bottom of the hole 12, to the heart of the wood, i.e. the wood's central part. This way the sound will play the sounds better and resonate better overall, and the wood plays the sounds evenly all around the wood.

In one adaptation, the equipment inside the hole is attached to the inner surface of the hole.

In another adaptation, the equipment inside the hole is attached to the inner surface of the hole by screwing.

In one adaptation, the transducer is attached with the help of a wood installation metal plate with two screws to the heart of the wood.

In FIG. 2, the leg 3 includes a top part flange 7 and a bottom part flange 8, and between them, a tube part 13. A power cord 9 comes from inside the wood 2, through the leg 3, along the hollow tube part, and underneath the bottom part flange 8 of the leg 3. Underneath the bottom part flange 8 are plastic pins 11, which lift the device from the ground enough for the power cord 9 to come from under the leg 3. The power cord 9 includes a switch 10 between the leg 3 and the plug.

In one adaptation, the pins 11 are of plastic, so that the device slides easily on the floor.

In one adaptation, the top part flange 7 covers the equipment inside the wood 2.

The invention is not limited to apply only according to the previously presented adaptations, but many modifications are possible when remaining within the inventive thought of the patent claims.

1. Sound playing wood (1) which includes a wood (2), a leg (3), and equipment inside the wood, where
the wood (2) is set on the leg (3) and a hole (12) is made at the bottom and inside the wood; and
the equipment includes an amplifier (4) and a computer (5), which are attached to the inner surface of the hole (12) inside the wood (2), characterised in that the equipment includes a transducer (6) attached to the inner surface of the wood to make the wood (2) vibrate.

2. The sound playing wood according to patent claim 1, wherein the transducer (6) is attached to the bottom, the central part, of the hole (12).

3. The sound playing wood according to claim 1, wherein in that the leg (3) is hollow.

4. The sound playing wood according to claim 3, wherein the hole (12) has an airflow connection to the outside of the device through the leg (3) functioning as a ventilation channel for the equipment inside the wood (2).

5. The sound playing wood according to claim 4 wherein the leg (3) includes a bottom part flange (8) at the bottom of the leg and pins (11) organised underneath the bottom part flange (8).

6. The sound playing wood according to claim 1, wherein the equipment includes a power cord (9), which is organised to go inside the leg (3) out from the wood (2).

7. The sound playing wood according to claim 6, wherein on the bottom surface of the bottom part flange (8) is a chute for the power cord (9).

8. The sound playing wood according to claim 1, wherein the equipment further includes a Bluetooth connection.

9. The sound playing wood according to claim 1 wherein the equipment further includes a Wi-fi connection.

10. The sound playing wood according to claim 1 wherin the wood (2) is made of naturally dried dead pine, birch or spruce.
